(19) United States
(12) Patent Application Publication
(10) Pub. No.: US 2008/0031690 A1
(43) Pub. Date: Feb. 7, 2008

(54) Device for Controlling and Actuating a Vibrating Mechanism

(75) Inventor: Martin Krick, Neunkirchen (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: HYDAC SYSTEM GMBH, 66280 SULZBACH/SARR, GERMANY (DE)

(21) Appl. No.: 10/591,992

(22) PCT Filed: Mar. 9, 2005
(86) PCT No.: PCT/EP05/02456

§ 371 Date: May 16, 2007

(30) Foreign Application Priority Data
Mar. 17, 2004 (DE) 10-2004-014.375.7

(51) Int. Cl. E02D 3/046; B06B 1/16; E01C 19/38

(52) U.S. Cl. 404/133.05; 404/84.05

(57) ABSTRACT

The device for controlling and actuating a vibrating mechanism, particularly in tampers, comprises a hydraulic pump (12) that drives a hydraulic motor (18), which interacts with the vibrating mechanism (10) while being a part of a hydraulic circuit (16) to which a pressure regulator (22) is connected in the secondary branch (20) and can be controlled by a hydraulic switching device (24). This configuration provides a purely hydraulic solution that does not require electrical current for controlling and switching off the vibrating mechanism.

The invention relates to a device for controlling and actuating a vibrating mechanism, especially for soil tamping machines.

Soil tamping machines, such as for example internal combustion engine-driven vibrating plates, which can be moved by hand on construction sites, for controlling the vibration mechanism which acts on the vibrating plate, have centrifugal clutches which can be electrically shut off via the corresponding operating switch. Furthermore, these soil tamping machines have a drive which makes it possible to move forward or backward by mass displacement, and to vibrate in place by means of the vibration mechanism and vibrating plate in order to deposit for example loose bulk or lump material as part of a ground covering on a corresponding substructure. As a result of electrical control via the operating switch an independent electrical system with a battery part is necessary and with respect to the sensitivity of the electronic and electrical components to mechanical stress, operating disruptions of the electrical system and thus of the soil tamping machine are possible, for example when an electrical cable or a corresponding contact detaches.

On the basis of this prior art, the object of the invention is to devise a device for controlling and actuating a vibration mechanism in a soil tamping machine which does not have the described disadvantages, especially even under severe operating conditions reliably enables control of the vibration mechanism. This object is achieved by a device with the features of claim 1 in its entirety.

The device as claimed in the invention is provided with a hydraulic pump which drives a hydraulic motor which interacts with the vibration mechanism as part of a hydraulic circuit, to which in the secondary branch a pressure regulator is connected which can be controlled by a hydraulic switching means. With this configuration of features, a purely hydraulic solution is implemented which manages without electrical current for controlling and turning off the vibration mechanism. Based on the purely hydraulic solution, operating reliability is largely ensured and the hydraulic solution can nonetheless be implemented in a cost-effective way. Additional, heavy batteries can likewise be omitted in this respect. Due to the very high volumetric flow of the hydraulic pump of 40 l/min and more in practical operation, the solution as claimed in the invention calls for a pressure regulator which controls the main volumetric flow, and the pressure regulator can be controlled by way of a switching means which, integrated in a space-saving manner, for example in the handle part of the soil tamping machine, enables reliable hydraulic control in a space-saving manner, since only a small amount of fluid, controlled by the hydraulic switching means, is necessary to control the pressure regulator.

In one especially preferred embodiment of the device as claimed in the invention, provision is made such that two opposing control spaces of the switching means, especially in the form of a 2/2-way valve, can be connected to each other to carry fluid, preferably provision furthermore being made such that the switching means has an energy storage device, especially in the form of a reset spring which tries to hold the switching means in its “off” position. If during operation of the vibration mechanism for some reason an emergency “off” function must be triggered, this takes place supported by way of the two control spaces and the indicated reset spring. The two control spaces of the switching means are unpressurized in the emergency “off” function.

In one especially preferred embodiment of the device as claimed in the invention, the system pressure is lowered via a pressure reducing valve and thus the control pressure is kept ready for the actual driving of the soil tamping machine.

Other advantageous embodiments are the subject matter of the other dependent claims.

The device as claimed in the invention for controlling and actuating a vibration mechanism will be detailed below using the drawings. The figures are schematic and not to scale.

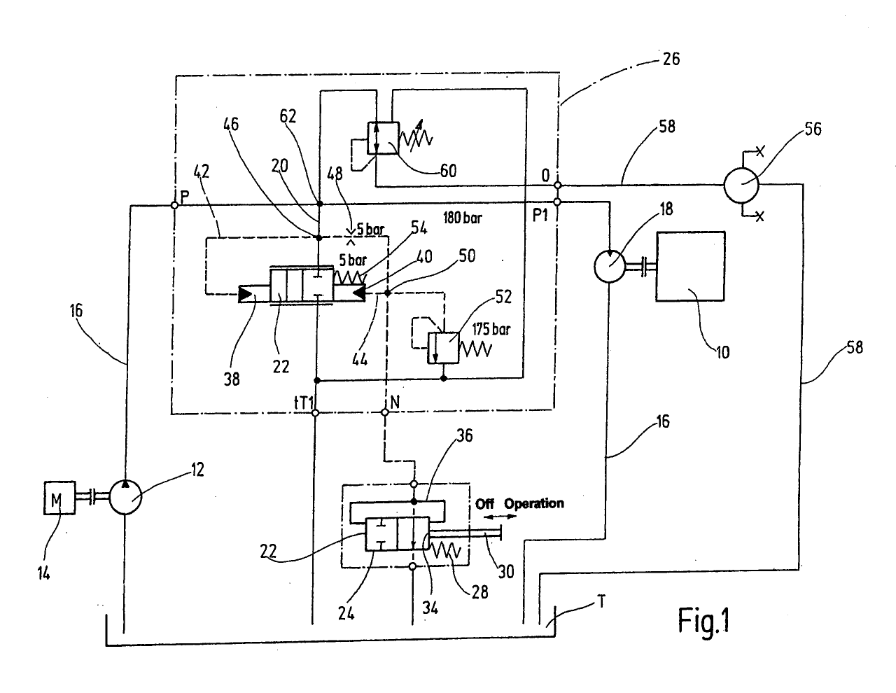

FIG. 1 shows in the form of a hydraulic circuit diagram the control and actuating device as claimed in the invention;

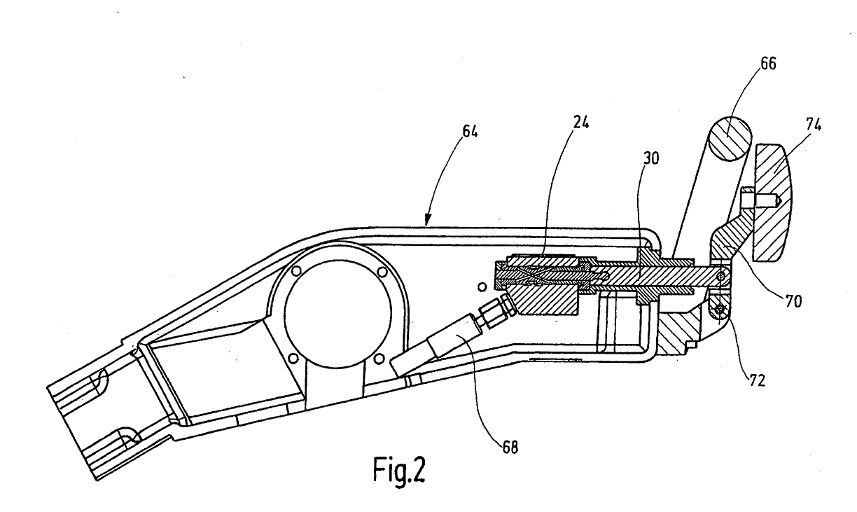

FIG. 2 shows partially in a section, partially in a front view, the top end of an operating handle for handling a manually movable soil tamping machine with a vibrating plate including the switching means;

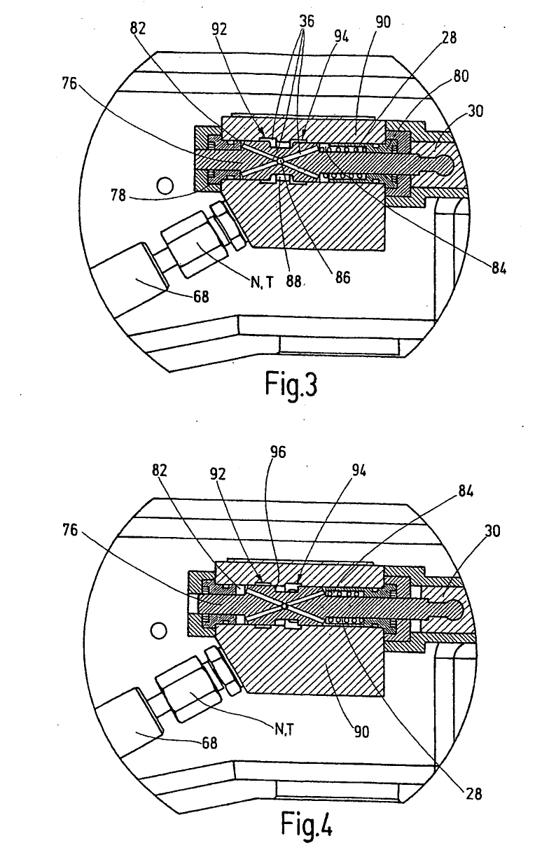

FIGS. 3 and 4 show the switching means shown in FIG. 2 in a circle sectional view in an enlargement, once in the operating position emergency “off”, once in the operating position “operation”.

FIG. 1 shows in the form of a hydraulic circuit diagram the overall device for controlling and actuating the vibration mechanism 10 with a hydraulic pump 12 which can be driven by an internal combustion engine (engine 14). The hydraulic pump 12 is part of a hydraulic circuit 16, the hydraulic pump 12 taking fluid, for example in the form of a hydraulic medium, from a tank T which is exposed to the ambient pressure and in circulation relays the fluid to a hydraulic motor 18 which is designed for driving the vibration mechanism 10. The design of these vibration mechanisms 10 in soil tamping machines is conventional so that it will not be detailed here.

In the secondary branch 20 to the hydraulic circuit 16 a conventional pressure regulator 22 is connected which is shown in FIG. 1 in its unactuated blocking position. This pressure regulator 22 can be controlled by a hydraulic switching means 24. The switching means 24 consists of a 2/2-way valve and as illustrated in FIG. 1 is shown in the “off” and emergency “off” position, in which there is a fluid-carrying connection between the connecting point N of a control unit designated as a whole as 26 and the tank T. In the base position shown in FIG. 1 the hydraulic switching means 24 therefore is at the “off” position in which the fluid-carrying input in the form of a connecting point (control connection) N of the switching means 24 is relieved to the tank pressure of the tank T. The switching means 24 furthermore has an energy storage device in the form of a reset spring 28 which tries to keep the switching means 24 in its “off” position which is shown in FIG. 1. To actuate the switching means 24 there is an actuating part 30 which moves the switching means from the “off” position shown in FIG. 1 into the operating position in which the fluid-carrying path between N and T is blocked. Furthermore, two opposing control spaces 32, 34 of the switching means 24 are connected to each other to carry fluid by way of at least one fluid path 36 and at the same time by way of a groove 88 to the control connection N of the control unit 26.

The pressure regulator 22 on either side has one control mean 38, 40 each which are connected to carry fluid via the control inputs 42, 44 to the fluid input 46 of the pressure regulator 22. This input 46 is part of the secondary branch 20. Furthermore, the second control input 44 is provided with a throttle valve 48, preferably with a setting value of 5 bar. By way of the node point 50 the connecting point N is connected to the second control input 44 to carry fluid and in this way to the pressure limiting valve 52 which has for example a setting value of 175 bar. The output of this pressure limiting valve 52 is connected to the tank T to carry fluid via the connecting point T₁ of the control unit 26. The output of the pressure regulator 22 also leads to the connecting point T₁. The pressure setting value of the indicated throttle valve 48 corresponds otherwise to the pressure setting value of a set spring 54 on the pressure regulator 22 which has the tendency to keep the pressure regulator 22 in its closed position shown in FIG. 1. The hydraulic pump 12 is connected to the control unit 26 by way of the pump connection P to carry fluid, and by way of other connecting points P₁ and O of the control unit 26 the hydraulic motor 18 can be operated on the one hand with the vibration mechanism 10 and on the other hand the actual drive 56 with which the soil tamping machine can be moved, specifically both in forward travel and in reverse travel, by mass displacement or with the possibility of standing in place and then vibrating by way of the vibration mechanism 10. This drive for soil tamping machines including a vibration machine with the vibrating plate is conventional so that it will no longer be detailed here. For fluid supply of the hydraulic drive 56 it has its own supply circuit 58 with a pressure reducing valve 60 which can be connected to the hydraulic circuit 16 with the formation of a parallel supply branch by way of a connecting point 62. Thus, the fluid pressure of for example 180 bar prevailing in the hydraulic circuit 16 can be reduced via the pressure reducing valve 60 to a pressure of 30 bar which is required in the supply circuit 58 to actuate the drive 46. This supply circuit 58 is also closed to the extent that it has a return to the tank T (compare FIG. 1).

For better understanding, the hydraulic switching device as shown in FIG. 1 is detailed using a functional sequence. When the internal combustion engine 14 is started up, for example electrically or mechanically by hand by means of a hand crank, with its rated speed, it drives the hydraulic pump 12 and the latter supplies the hydraulic circuit 16 with fluid from the tank T. In the base position which corresponds to the “off” or emergency “off” position, the switching means 24 is located in its passage position shown in FIG. 1 with the connection N linked to the tank T. Since in this respect then in the direction of looking at FIG. 1 there is no pressure on the right control input 44, the control means 38 is actuated via the control input 42 and the pressure regulator 22 is switched into its passage position in which the input 46 of the pressure regulator 22 is connected to the tank T via the connecting point T₁. The delivery flow in the hydraulic circuit 16 is then in unpressurized circulation to the tank T. The switching means 24 in the form of the 2/2-valve is held via its reset spring 28 in this base position and even when the soil tamping machine (not shown) in turned off after the control pressure drops, this “off” position is automatically switched via the reset spring 28.

In order to start the vibration mechanism 10 with the vibrating plate, the hydraulic motor 18 must be controlled. This takes place by the switching means 24 being moved by hand by way of the actuating part 30 into its blocked position which corresponds to the operation of the soil tamping machine. The pressure which now builds up via the second control input 44 in conjunction with the set spring 54 provides for the pressure regulator 22 to move into its position which is closed in FIG. 1 and in which the input 46 is separated from the connecting point T₁ by way of the pressure regulator 22. Since the pressure regulator 22 works as a slide valve, depending on the pressure situation it is possible for intermediate positions to be assumed between fully opened and fully closed. Since at this point both the pressure regulator 22 and also the switching means 24 are in their blocked position, the system pressure of the hydraulic pump 12 is relayed via the connecting point 62 to the output T₁ of the control unit 26 for purposes of driving the hydraulic motor 18 for the vibration mechanism 10. Parallel to this, for controlling the drive 56 the prevailing system fluid pressure can be relayed via the pressure reducing valve 60 in this way. Accordingly it would be possible to vibrate with the soil tamping machine in forward or reverse travel at the same time with the vibrating plate or vibrating rollers by way of the vibration mechanism 10 for purposes of soil tamping. When the actuation part 30 is actuated for the purpose of an emergency “off”, then the pump again delivers in unpressurized circulation and the valve of the switching means 24 then keeps itself in the emergency “off” position. At the same time then both vibration and also any forward and reverse travel are immediately interrupted; this greatly increases the safety of the device as claimed in the invention.

FIG. 2 shows the upper part of a handle which is designated as a whole as 64 and which is provided on the free end with a bow-type grip 66 which in conjunction with the handle 64 allows an operator to move the soil tamping machine, for example in the form of a vibrating plate tamper, by hand to the intended locations where soil tamping or tamping of material to be deposited are to take place. This grip construction is conventional in soil tamping machines so that it will no longer be detailed here. In the direction of the bow-type grip 66 within the shaft-like handle 64 the aforementioned switching means 24 is held in the form of a 2/2-way valve. The fluid supply of the switching means 24 takes place via a supply line 68 in which the lines for the connecting point N are routed, as well as the connecting lines for the tank T. To actuate the switching means 24 the actuating part 30 is routed fluid-tight out of the handle 64 in the manner of an actuating rod and can be movably connected to an operating lever 70 which on its lower end is pivotally connected via a swivel point 72 on the handle 64 and on its upper end has a control button 74. In the actuating position shown in FIG. 2 the switching means 24 is switched to emergency “off”, i.e. the pressure regulator 22 controlled by the switching means 24 provides for unpressurized circulation of the fluid which is delivered from the hydraulic pump 12 into the circuit 16. Both the drive 56 and also the mechanism 10 are turned off in this way.

In FIG. 3 this switching situation as shown in FIG. 2 is reproduced enlarged for the parts located in the circuit as shown in FIG. 2. The valve piston 76 of the switching means 24 is guided pressure-tight on the end side and sealed in the receiving parts 78, 80, the receiving part 80 forming an annular recess in the form of a receiving sleeve in which the reset spring 28 of the switching means 24 is held. Viewed in the direction of looking at FIG. 3, the valve piston 76 with a spherical extension engages a corresponding recess in the rod-shaped actuating part 30. In the “off” or emergency “off” position shown in FIG. 3, the valve piston 76 accordingly is in its left stop position with the receiving sleeve 78 and one control space 82 is reduced essentially to zero, conversely the other control space 84 with the reset spring 28 has its greatest volume.

These control spaces 82, 84 are connected to each other to carry fluid via diagonally running fluid paths 36, and via a transversely running connecting point 86 a fluid-carrying connection to a groove-like center recess 88 in the valve piston 76 can be produced. Furthermore, the valve piston 76 is guided in a housing 90 which has two widening annuli 92, 94 which are connected to the center recess 88. The annulus 92 is connected to the tank T to carry fluid and the other annulus 94 is connected to the connecting point N. In the “off” or emergency “off” position shown in FIG. 3, a fluid-carrying connection between the connecting point N and the tank T the annuli 92, 94 and the middle recess 88 is established [sic] and this operating diagram as shown in FIG. 3 corresponds to the operating diagram as shown in FIG. 1, to the extent the switching means 24 is referred to in the form of a 2/2-way valve.

As shown in FIG. 4 which in turn shows the same sectional view as FIG. 3, the switching means 24 is shown in its operating position, in which by actuating the control button 74 the rod-shaped actuating part 30 is moved from left to right. Accordingly the control space 84 travels back as far as the annulus with the reset spring 28 to zero and the control space 82 becomes correspondingly larger with the motion of the valve piston 76 from left to right, viewed in the direction of looking at FIG. 4. The reset spring 28 is now pretensioned and the two annuli 92, 94 are separated from each other via the control edge 96 of the valve piston. This leads to the pressure regulator 22, as already described, likewise assuming its blocking position as shown in FIG. 1 and then both the vibration mechanism 10 and also the hydraulic drive 6 can be started.

The control surface of the control space 82 is selected to be larger than the control surface of the control space 84 such that a sufficient excess of force results compared to the combined force of hydraulic force and spring force of the reset spring 28. Thus the valve piston 76 is held in the operating position if operational actuation is initiated via the control button 74 by pulling. In an emergency situation the control button 74 during operation can then be pressed into the “off” or emergency “off” position and the control button 74 is then pressed as far as a stop against the force difference and the breakaway torque of the valve piston seals in the two receiving parts 78, 80, and is then held in this position. By means of the pressure regulator 22 reliable control of the relatively high volumetric flow of the hydraulic pump 12 of for example approximately 40 l/min is ensured with relatively small control currents which can be managed by a switching means 24 which can be housed in the grip of the soil tamping machine. With the solution as claimed in the invention, consisting of a pressure regulator, the pressure limiting valve and the diaphragm or throttle valve, it is possible to control only the pilot pressure for the pressure regulator 22 via the switching means 24 in order in this way to be able to control the sequence of movements of the entire soil tamping machine.

1. Device for controlling and actuating a vibrating mechanism, especially in soil tamping machines, having a hydraulic pump (12) which drives a hydraulic motor (18) which interacts with the vibrating mechanism (10) as part of a hydraulic circuit (16), to which in the secondary branch (20) a pressure regulator (22) is connected which can be controlled by a hydraulic switching means (24).

2. The device as claimed in claim 1, wherein in the base position the hydraulic switching means (24) is at the “off” position in which the fluid-carrying input (connection N) of the switching means (24) is relieved to the tank pressure.

3. The device as claimed in claim 2, wherein the switching means (24) has an energy storage device, especially in the form of a reset spring (28) which tries to hold the switching means (24) in its “off” position.

4. The device as claimed in claim 1, wherein two opposing control inputs (42, 44) of the pressure regulator (22) are connected to its fluid input (46) and wherein one of these control inputs (44) is connected to the input (connection N) of the switching means (24) to carry fluid.

5. The device as claimed in claim 4, wherein a throttle valve (48) is connected to the connecting line between the control inputs (42, 44) of the pressure regulator (22) and the switching means (24) and upstream of the branch to one of the control means (40) for the pressure regulator (22).

6. The device as claimed in claim 5, wherein the pressure adjustment value of the throttle valve (48) corresponds to the pressure adjustment value of a set spring (54) on the pressure regulator (22) which is assigned to the control means (40) to which the throttle valve (48) is connected.

7. The device as claimed in claim 6, wherein the pressure regulator (22) spring-reinforced assumes a blocking position which interrupts the fluid-carrying connection between the input (46) of the pressure regulator (22) and tank (T) and establishes the pertinent fluid-carrying connection in the passage position.

8. The device as claimed in claim 1, wherein the switching means (24) is a 2/2-way valve.

9. The device as claimed in claim 1, wherein the two opposing control spaces (32, 34) of the switching means (24), especially in the form of a 2/2-way valve, can be connected to each other to carry fluid.

10. The device as claimed in claim 9, wherein an excess of force is produced in the control space (32) by the different area ratios in the two control spaces and keeps the switching means (24) in the “operation” position against the combined forces resulting from the energy storage device (28) and the hydraulic force of the control space (34).

11. The device as claimed in claim 1, wherein by means of the pressure reducing valve (60) in the continuing hydraulic circuit (58) the system pressure produced by the hydraulic pump (12) can be lowered to a definable value for the hydraulic drive (56) of the soil tamping machine.

12. The device as claimed in claim 1, wherein there is a pressure limiting valve (52) for safeguarding the maximum pressure.
